(19) United States
(12) Patent Application Publication
(10) Pub. No.: US 2020/0412854 A1
(43) Pub. Date: Dec. 31, 2020

(54) Terminal Device

(71) Applicant: Wuhan China Star Optoelectronics Technology Co., LTD., Hubei (CN)

(72) Inventor: Wei CHENG, Hubei (CN)

(73) Assignee: Wuhan China Star Optoelectronics Technology Co., Ltd., Hubei (CN)

(21) Appl. No.: 16/485,443

(22) PCT Filed: Apr. 24, 2019
(86) PCT No.: PCT/CN2019/084114

§ 371 Date: Aug. 13, 2019

(30) Foreign Application Priority Data
Nov. 28, 2018 (CN) 201811436789.X

(51) Int. Cl. H04M 1/02; G02F 1/1334; G02F 1/163; G06F 1/16

(52) U.S. Cl. CPC H04M 1/0266; G02F 1/1334; G02F 2001/1635; H04M 1/0264; G06F 1/165; G02F 1/163

(57) ABSTRACT

Disclosed is a terminal device. The terminal device includes a first display screen, a second display screen adjacent to the first display screen, and a front-facing camera module disposed under the second display screen. The first display screen is a display screen normally used in the terminal device, and the front-facing camera module is disposed under the second display screen. When the terminal device performs photographing and the front-facing camera module begins working, the second display screen is in a transparent state to implement the function of photographing of the terminal device. When the terminal device does not perform photographing and the front-facing camera module does not work, the second display screen is in a non-transparent state to display the information of the terminal device, thereby achieving the full screen display terminal device without the free-form area, improving a screen-to-body ratio of the terminal device.

### FIELD OF INVENTION

The present invention relates to the display technical field, and in particular, to a terminal device.

### BACKGROUND OF INVENTION

Thin film transistors are main driving components in current liquid crystal displays and active matrix organic light-emitting diode displays, which are directly related to display performance of flat-panel display devices.

Most of the liquid crystal displays that are currently available in the market are backlight liquid crystal displays, which comprise a liquid crystal panel and a backlight module. The operation principle of the liquid crystal panel is filling liquid crystal molecules between a thin film transistor array substrate and a color filter substrate and then applying pixel voltage and common voltage to the two substrates in such a manner that the light of the backlight module is refracted to generate images by an electric field formed between the pixel voltage and the common voltage for controlling the rotation direction of the liquid crystal molecules.

Currently, free-form areas of free-form displays available in the hypermarket which include the hole in display, notch and widow's peak are widely applied to products from major mobile phone manufacturers. For example, manufacturers, such as IPHONE, MI and HUAWEI have launched more and more free-form displays for seeking a higher screen-to-body ratio and positive user experience. However, the structure of free-form area of the display screen still cannot be accepted by many end users seeking the higher screen-to-body ratio, which is also the main reason that a notch remover application is launched while IPHONE X is on the market.

The structure of the current display screen of the free-form displays available in the market are shown in FIG. 1. The free-form area mainly includes the types of widow's peak, notch, and hole in display. The front-facing camera of the mobile phone is disposed at the drilled free-form area.

In the free-form displays, the free-form area appears dark under the circumstance where the screen lights up for operation still cannot be accepted by most consumers and end users.

Thus, there is a need for providing a terminal device to improve the current free-from displays.

### SUMMARY OF INVENTION

An object of the present invention is to provide a terminal device, which can achieve the full screen display terminal device without the free-form area so as to improve the screen-to-body ratio of the terminal device.

In order to achieve the above object, the present invention provides a terminal device includes: a first display screen, a second display screen adjacent to the first display screen, and a front-facing camera module disposed under the second display screen; wherein the second display screen is in a transparent state while the front-facing camera module is in operation, and the second display screen is in a non-transparent state while the front-facing camera module is not in operation.

The second display screen is a polymer dispersed liquid crystal display screen.

The second display screen is in the transparent state while an electric field is applied to polymer dispersed liquid crystal as the front-facing camera module is in operation, and the second display screen is in the non-transparent state while no electric field is applied to the polymer dispersed liquid crystal as the front-facing camera module is not in operation.

The front-facing camera module comprises a plurality of spaced-apart front-facing cameras.

The terminal device further comprises a facial recognition module disposed under the second display screen.

The second display screen is further in the transparent state while the facial recognition module is in operation, and the second display screen is in the non-transparent state while the facial recognition module is not in operation.

The second display screen is located at an upper area of the terminal device, and the first display screen is located at a lower area of the terminal device.

The second display screen displays a top status bar information of the terminal device while the second display screen is in the non-transparent state.

The top status bar information comprises signal status, power, time, and an operator of the terminal device.

An area of the first display screen is more than an area of the second display screen.

The present invention has the beneficial effects that a terminal device of the present invention includes a first display screen, a second display screen adjacent to the first display screen, and a front-facing camera module disposed under the second display screen. The first display screen is a display screen normally used in the terminal device, and the front-facing camera module is disposed under the second display screen. When the terminal device performs photographing and the front-facing camera module begins working, the second display screen is in a transparent state to implement the function of photographing of the terminal device. When the terminal device does not perform photographing and the front-facing camera module does not work, the second display screen is in a non-transparent state to display the information of the terminal device, thereby achieving the full screen display terminal device without the free-form area, improving the screen-to-body ratio of the terminal device. Moreover, hole drilling, notching and other processes can be eliminated to reduce the cost and to avoid process loss resulting from such as laser grinding so as to improve the product yield and reliability.

### BRIEF DESCRIPTION OF THE DRAWINGS

The characteristic features and the technical solutions of the present invention are best understood from the following detailed description with reference to the accompanying figures. However, the accompanying figures are only provided for the reference and illustration, but not to limit the present invention.

In the drawings:

FIG. 1 is a schematic view of a conventional free-form display.

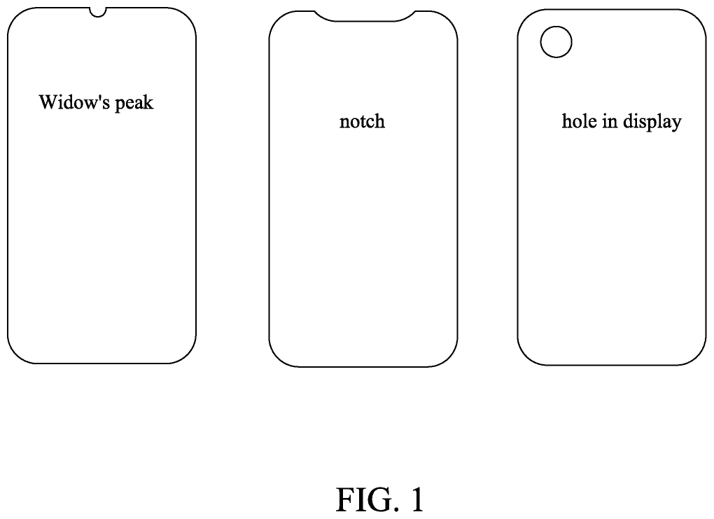

FIG. 2 is a schematic view of a terminal device of the present invention.

FIG. 3 is a cross-sectional view taken along line A-A in FIG. 2.

### DETAILED DESCRIPTION OF EMBODIMENTS

In order to further elaborate the technical means and effects adopted by the present invention, the present invention will be further described in detail with the preferred embodiments and the accompanying drawings.

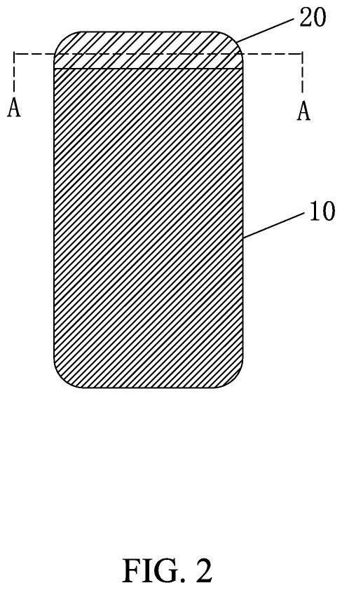

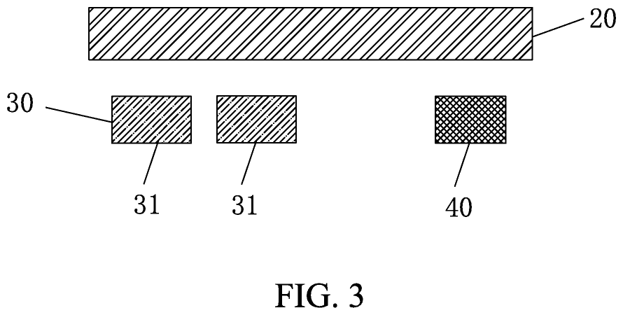

Please refer to FIG. 2 and FIG. 3, the present invention provides a terminal device, including: a first display screen 10, a second display screen 20 adjacent to the first display screen 10, and a front-facing camera module 30 disposed under the second display screen 20. The second display screen 20 is in a transparent state while the front-facing camera module 30 is in operation, and the second display screen 20 is in a non-transparent state while the front-facing camera module 30 is not in operation.

It should be noted that, the terminal device of the present invention is provided with two display screens. The first display screen 10 is a display screen normally used in the terminal device, and the front-facing camera module 30 is disposed under the second display screen 20. When the terminal device performs photographing and the front-facing camera module 30 begins working, the second display screen 20 is in a transparent state to implement photography functions of the terminal device. When the terminal device does not perform photographing and the front-facing camera module 30 does not work, the second display screen 20 is in a non-transparent state to display the information of the terminal device, thereby achieving the full screen display terminal device without the free-form area, improving the screen-to-body ratio of the terminal device. Moreover, hole drilling, notching and other processes can be eliminated to reduce the cost and to avoid process loss resulting from such as laser grinding so as to improve product yield and reliability.

Specifically, the second display screen 20 is a polymer dispersed liquid crystal display screen. The polymer dispersed liquid crystal is a liquid crystal dispersed in an organic solid polymer matrix in a micro amount of microdroplets. When there is no electric field applied to the polymer dispersed liquid crystal, since the optical axis of the microdroplets composed of liquid crystal molecules is in a free orientation and the refractive index of the microdroplet does not match the refractive index of the substrate, the light is scattered by the microdroplets strongly when passes through the substrate, and thereby the second display 20 is in a non-transparent state. When an electric field is applied to the polymer dispersed liquid crystal, the optical axis orientation of the liquid crystal microdroplets can be adjusted. The second display 20 is in a non-transparent state when the refractive index of the liquid crystal microdroplet matches the refractive index of the substrate. That is, the second display screen 20 is in the transparent state while an electric field is applied to polymer dispersed liquid crystal as the front-facing camera module 30 is in operation, and the second display screen 20 is in the non-transparent state while no electric field is applied to the polymer dispersed liquid crystal as the front-facing camera module 30 is not in operation.

Specifically, the terminal device further comprises a facial recognition module 40 disposed under the second display screen 20. The face recognition module 40 can identify the holder of the terminal device when the terminal device needs to identify the user information such as unlocking or paying using the terminal device. The second display screen 20 is further in the transparent state while the facial recognition module 40 is in operation, and the second display screen 20 is in the non-transparent state while the facial recognition module 40 is not in operation. That is, the second display screen 20 is further in the transparent state while the front-facing camera module 30 and the facial recognition module 40 are in operation, and the second display screen 20 is in the non-transparent state while the front-facing camera module 30 and the facial recognition module 40 are not in operation.

Specifically, the first display screen 10 is a liquid-crystal display screen.

Specifically, the front-facing camera module 30 comprises a plurality of spaced-apart front-facing cameras 31. Since the area of the second display screen 20 is more than the free-from area of the current free-form display screen, and thus there is enough space under the second display screen 20 to dispose the plurality of front-facing cameras 31 to improve image quality, thereby improving user experience.

Specifically, the terminal device is a mobile phone. The terminal device can also be a device such as a tablet computer, and the present invention is not limited herein.

Specifically, the second display screen 20 is located at an upper area of the terminal device, and the first display screen 10 is located at a lower area of the terminal device.

Further, an area of the first display screen 10 is more than an area of the second display screen 20, and the first display screen 10 is used for displaying the normal display information of the terminal device.

Specifically, the second display screen 20 displays a top status bar information of the terminal device while the second display screen is in the non-transparent state. The top status bar information comprises signal status, power, time, and an operator of the terminal device.

As mentioned above, the terminal device of the present invention includes a first display screen, a second display screen adjacent to the first display screen, and a front-facing camera module disposed under the second display screen. The first display screen is a display screen normally used in the terminal device, and the front-facing camera module is disposed under the second display screen. When the terminal device performs photographing and the front-facing camera module begins working, the second display screen is in a transparent state to implement the function of photographing of the terminal device. When the terminal device does not perform photographing and the front-facing camera module does not work, the second display screen is in a non-transparent state to display the information of the terminal device, thereby achieving the full screen display terminal device without the free-form area, improving the screen-to-body ratio of the terminal device. Moreover, hole drilling, notching and other processes can be eliminated to reduce the cost and to avoid process loss resulting from such as laser grinding so as to improve the product yield and reliability.

Based on the description mentioned above, those having ordinary skills of the art may easily contemplate various changes and modifications of the technical solution and technical ideas of the present invention and all these changes and modifications are considered within the protection scope of right for the present invention.

What is claimed is:

1. A terminal device including: a first display screen, a second display screen adjacent to the first display screen, and a front-facing camera module disposed under the second display screen;
wherein the second display screen is in a transparent state while the front-facing camera module is in operation, and the second display screen is in a non-transparent state while the front-facing camera module is not in operation.

2. The terminal device of claim 1, wherein the second display screen is a polymer dispersed liquid crystal display screen.

3. The terminal device of claim 2, wherein the second display screen is in the transparent state while an electric field is applied to polymer dispersed liquid crystal as the front-facing camera module is in operation, and the second display screen is in the non-transparent state while no electric field is applied to the polymer dispersed liquid crystal as the front-facing camera module is not in operation.

4. The terminal device of claim 1, wherein the front-facing camera module comprises a plurality of spaced-apart front-facing cameras.

5. The terminal device of claim 1, further comprising a facial recognition module disposed under the second display screen.

6. The terminal device of claim 5, wherein the second display screen is further in the transparent state while the facial recognition module is in operation, and the second display screen is in the non-transparent state while the facial recognition module is not in operation.

7. The terminal device of claim 1, wherein the second display screen is located at an upper area of the terminal device, and the first display screen is located at a lower area of the terminal device.

8. The terminal device of claim 7, wherein the second display screen displays a top status bar information of the terminal device while the second display screen is in the non-transparent state.

9. The terminal device of claim 8, wherein the top status bar information comprises signal status, power, time, and an operator of the terminal device.

10. The terminal device of claim 1, wherein an area of the first display screen is more than an area of the second display screen.
